(19) United States
(12) Patent Application Publication
(10) Pub. No.: US 2011/0241273 A1
(43) Pub. Date: Oct. 6, 2011

(54) ONE-PIECE MULTI-LAYER SINTERING CARRIER

(76) Inventor: Te-Sheng CHIANG, Yonghe City (TW)

(21) Appl. No.: 12/753,945

(22) Filed: Apr. 5, 2010

(51) Int. Cl. B23Q 3/00

(52) U.S. Cl. 269/296

(57) ABSTRACT

A one-piece multi-layer sintering carrier includes plural vertical rods, plural X-directed transversal rods, plural Y-directed transversal rods and at least two holding plates. X-directed holes and Y-directed holes, which are mutually perpendicular, are provided in spacing on outer walls of the vertical rods. The plural X-directed transversal rods and the plural Y-directed transversal rods are fixed respectively at the X-directed holes and the Y-directed holes. The vertical rods are connected and tightly fitted as one unit through the X-directed transversal rods and the Y-directed transversal rods. The holding plates are accommodated on multi-layer horizontal planes formed by the plural X-directed transversal rods between the vertical rods. A distance between the layers can be designed according to requirements of continuous in-furnace longitudinal and transversal ventilation. Therefore, the present invention is an integrally formed sintering carrier with practical progressiveness and is highly ventilative and customizable.

### BACKGROUND OF THE INVENTION

a) Field of the Invention

The present invention relates to a one-piece multi-layer sintering carrier and more particularly to a one-piece multi-layer sintering carrier which is highly ventilative and customizable.

b) Description of the Prior Art

In general, after a heat treatment product (chinaware or a hardened piece, etc.) has been put on a heat treatment carrier, the carrier and the heat treatment product are orderly stacked in heat treatment equipment (commonly referred to as a kiln or a furnace) to conduct heating or cooling (commonly referred to as sintering or annealing). Conventionally, the carriers are divided into a type A and a type B.

The type-A carrier is commonly called a box which is in a pentahedral shape. The heat treatment products are put in the boxes and then the boxes are one by one orderly stacked in the kiln or furnace (the heat treatment equipment). The boxes can be also assembled together.

The type-B carrier is commonly called a rack (normally an assembly of shelf plates and supports), wherein a shelf plate is put on a top of three or four supports and after a sintering product has been put on the shelf plate, three or four supports are put on the shelf plate again, followed by putting another shelf plate on the supports, with the supports and the shelf plates being stacked orderly.

The rack-type carriers can be assembled integrally by assembling the shelf plates and the supports as one piece (solid body).

Nevertheless, when using the aforementioned heat treatment carrier, following issues and shortcomings actually exist to be improved.

Both the type-A box and the type-B rack are provided with a common feature that after one layer has been stacked, another layer is stacked on the top of it. This stacking method is very convenient when dealing with a large-scaled object. However, when dealing with a small object (such as an electronic element like MLCC (Multi-Layer Ceramic Capacitor)), as the heat treatment is performed continuously, movement of the carriers in the furnace will easily cause the boxes or the racks to displace horizontally to drop out, resulting in an imperfect product; or, imperfect ventilation from left to right or from front to rear may be induced due to a design reason, which further results in an imperfect temperature distribution in the furnace. Therefore, the improvement is indeed required.

Accordingly, how solve the aforementioned issues and shortcomings of the prior art is a direction of research and development for improvement by the present inventor and related vendors.

### SUMMARY OF THE INVENTION

The primary object of the present invention is to provide a heat treatment carrier which is highly ventilative, customizable and formed integrally.

To achieve the aforementioned object, the one-piece multi-layer sintering carrier, according to the present invention, includes plural vertical rods, plural X-directed transversal rods, plural Y-directed transversal rods and at least two holding plates. Outer walls of every vertical rod are provided in spacing with X-directed holes and Y-directed holes which are mutually perpendicular. The plural X-directed transversal rods and the plural Y-directed transversal rods are fixed respectively at the X-directed holes and the Y-directed holes. The vertical rods are connected and tightly fitted as one unit through the X-directed transversal rods and Y-directed transversal rods. The holding plate can be accommodated on a multi-layer horizontal plane which is formed by the plural X-directed transversal rods between the vertical rods and the holding plate can be placed with at least one pre-determined sintering object.

By the aforementioned structures, before sintering, the sintering object (such as a passive electronic element like MLCC) is put on the holding plate and then the holding plate, along with the sintering object, is inserted on the multi-layer (more than two layers) horizontal plane formed by the plural X-directed transversal rods. Next, this one-piece multi-layer carrier is put into a continuous sintering furnace for sintering.

A height of the vertical rods of the one-piece multi-layer sintering carrier, of the present invention, can be designed according to an effective height of heat treatment equipment (kiln or furnace) of a customer and spacing on the vertical rod can be designed depending on longitudinal and transversal ventilation in the furnace of the customer. The one-piece multi-layer design can save time of transportation and there will be no sliding out during transportation or movement in the heat treatment. Therefore, work convenience can be improved effectively and the continuous heat treatment in the furnace longitudinally and transversally can all have the good ventilation. If the holding plate is further configured as a multi-hole plate, then hot air convection between top and bottom in the furnace is also improved significantly, such that a temperature on a cross section of the heat treatment equipment (kiln or furnace) can be distributed more evenly and uniformity of a product quality can be better.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows a three-dimensional exploded view of the preferred embodiment of the present invention.

FIG. 3 shows a first schematic view of an implementation of the preferred embodiment of the present invention.

FIG. 4 shows a second schematic view of the implementation of the preferred embodiment of the present invention.

FIG. 5 shows a schematic view of an implementation of another preferred embodiment of the present invention.

FIG. 6 shows a schematic view of an implementation of still another preferred embodiment of the present invention.

### DETAILED DESCRIPTION OF THE PREFERRED EMBODIMENTS

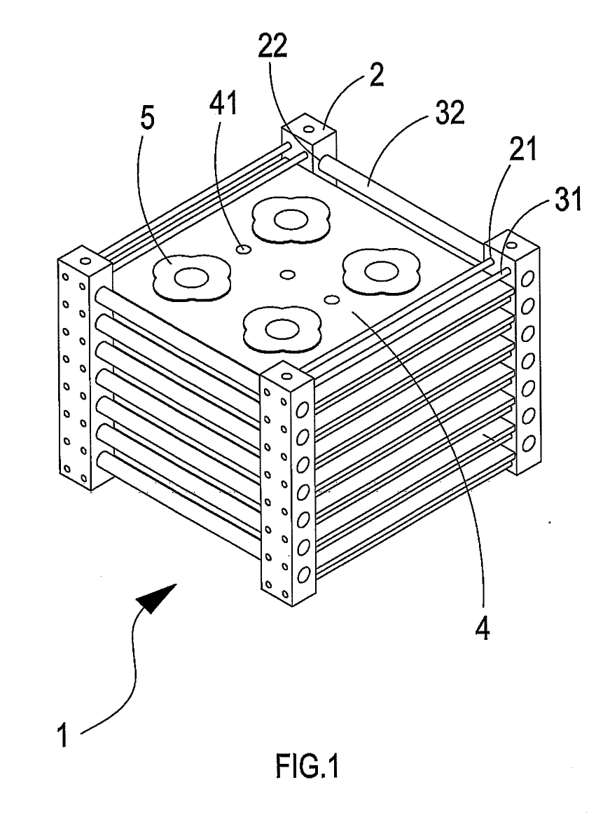

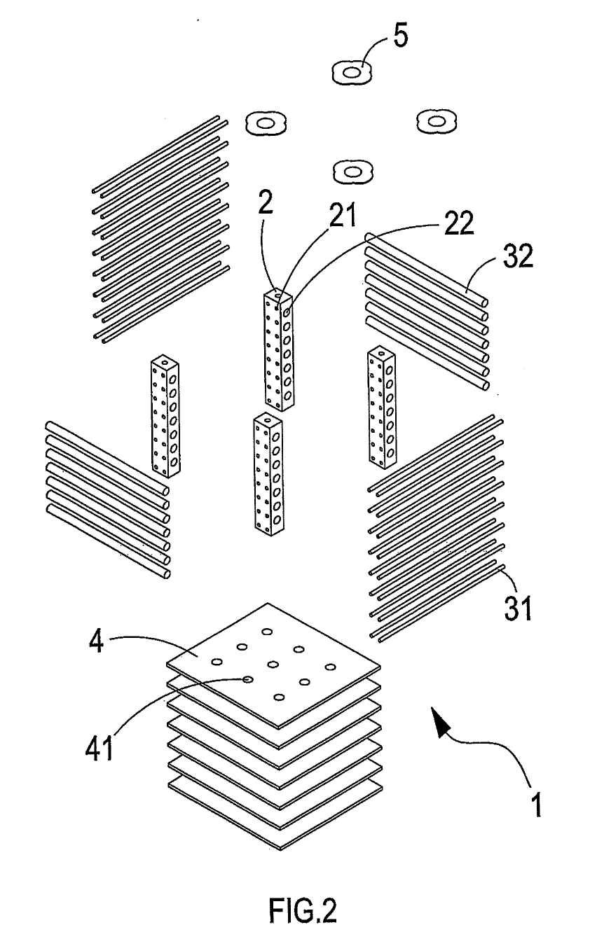

Referring to FIG. 1 and FIG. 2, it shows a three-dimensional view and a three-dimensional exploded view, of a preferred embodiment of the present invention. As shown in the drawings, a one-piece multi-layer sintering carrier 1, according to the present invention, comprises plural vertical rods 2, with that X-directed holes 21 and Y-directed holes 22, which are mutually perpendicular, are provided in spacing on outer walls of every vertical rods 2, respectively; plural X-directed transversal rods 31 and plural Y-directed transversal rods 32 which are fixed in the X-directed holes 21 and the Y-directed holes 22 respectively, with that the vertical rods 2 are connected and tightly fitted as one unit through the X-directed transversal rods 31 and the Y-directed transversal rods 32; and at least two holding plates 4 which are accommodated between the vertical rods 2, on multi-layer horizontal planes constituted by the X-directed transversal rods 31, with that the holding plates 4 are placed with at least one pre-determined sintering object 5 and are penetrated with plural holes 41 for ventilation.

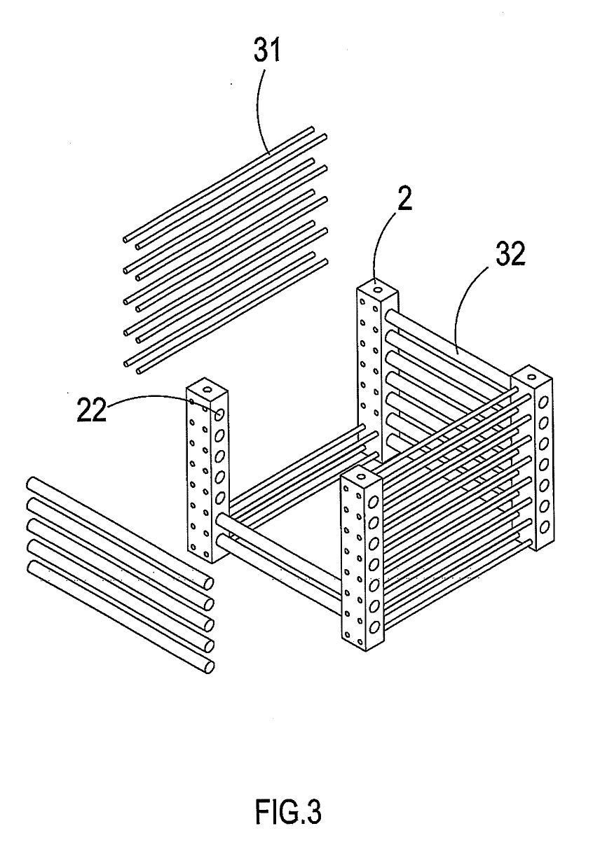

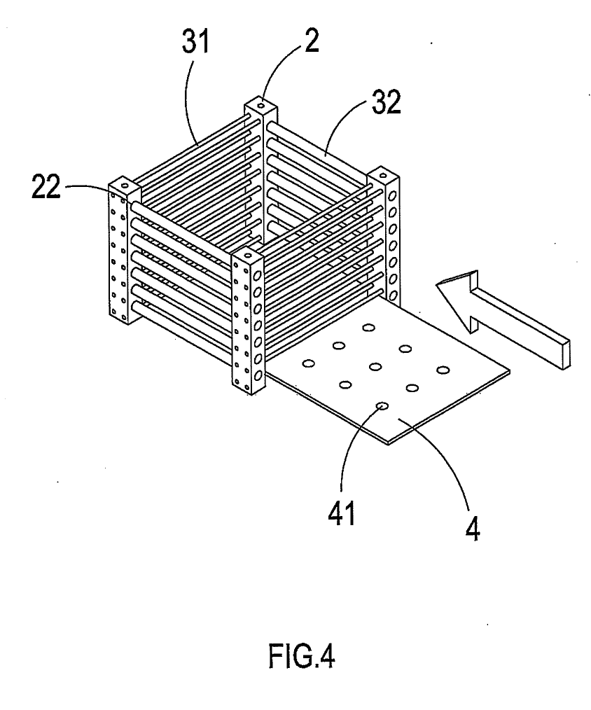

Referring to FIGS. 2 to 4, it shows the three-dimensional exploded view, a first schematic view of an implementation and a second schematic view of the implementation, of the preferred embodiment of the present invention. As shown in the drawings, the present invention is assembled by four vertical rods 2, plural X-directed transversal rods 31, plural Y-directed transversal rods 32 and at least two holding plates 4, wherein the outer walls of the vertical rods 2 are opened respectively with the plural X-directed holes 21 and Y-directed holes 22, with that the plural X-directed transversal rods 31 and the plural Y-directed transversal rods 32 are tightly fitted at the X-directed holes 21 and the Y-directed holes 22 in two directions (X-direction and Y-direction) of the vertical rods 2 and all the vertical rods 2 are effectively assembled as one unit through the plural X-directed transversal rods 31 and the plural Y-directed transversal rods 32, enabling the one-piece multi-layer sintering carrier 1 to be provided with plural layers; whereas, the tight fitting method is to assemble green bodies of the long non-sintered vertical rods 2 having the plural holes in two directions with the plural X-directed sintered transversal rods 31 and the plural Y-directed sintered transversal rods 32 as a semi-product of the one-piece multi-layer sintering carrier 1, and then to put this semi-product in a kiln for sintering. As contraction is resulted using the sintering to shrink the X-directed holes 21 and the Y-directed holes 22 of the vertical rods 2, the X-directed transversal rods 31 and Y-directed transversal rods 32, which are inserted into the X-directed holes 21 and Y-directed holes 22, are effectively fixed, thereby tightly fitting the one-piece multi-layer sintering carrier 1 as a solid body.

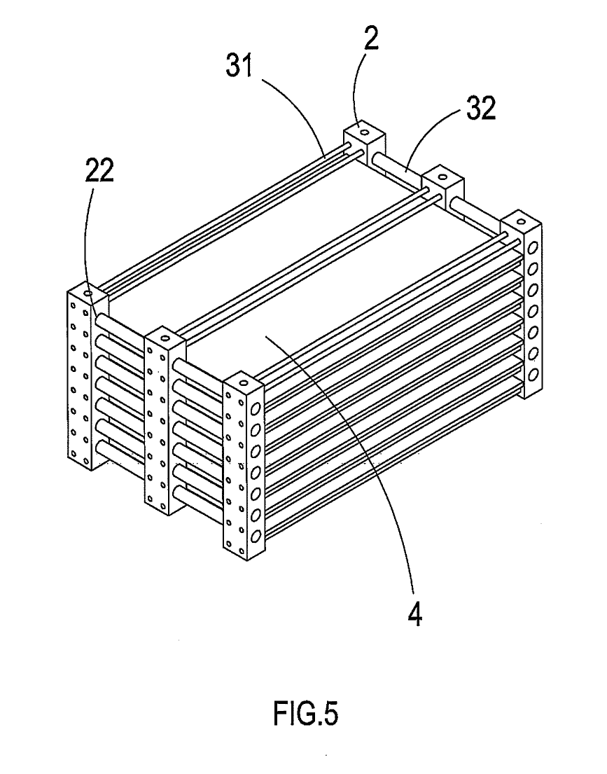

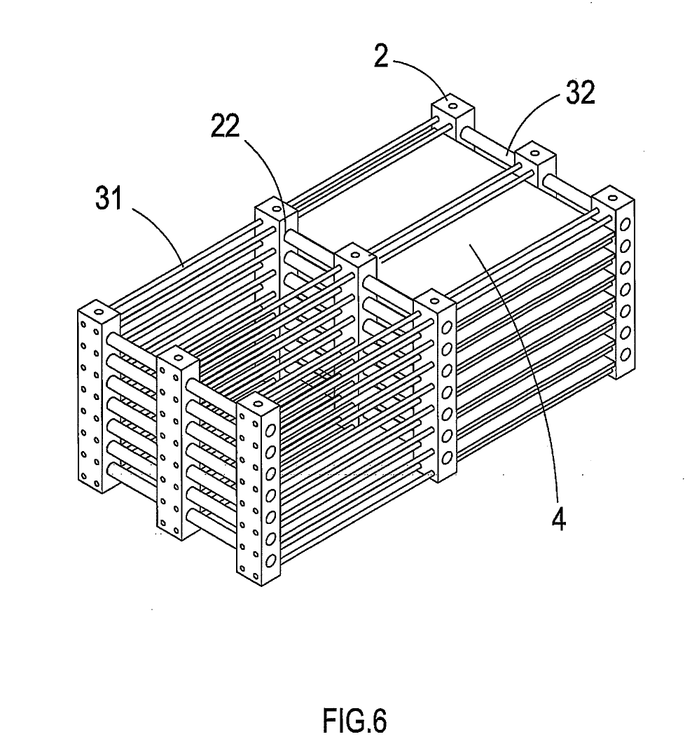

Referring to FIGS. 2, 5 and 6, it shows the three-dimensional exploded view of the preferred embodiment of the present invention, a schematic view of an implementation of another preferred embodiment of the present invention and a schematic view of an implementation of still another preferred embodiment of the present invention. As shown in the drawings, six or nine vertical rods 2 of the present invention can be provided. When performing a sintering operation to the sintering object 5, the sintering object 5 is first put on the holding plate 4 which can have no hole or plural holes. However, if the holding plate 4 is opened with plural holes 41, then a better ventilation effect is available. Next, the holding plate 4, along with the sintering object 5, is inserted into the one-piece multi-layer sintering carrier 1; whereas, when putting the holding plate 4, the holding plate 4 can be supported by the plane which is formed by the plural X-directed transversal rods 31. Then, this carrier is put in a furnace for sintering. As the plural X-directed transversal rods 31, the plural Y-directed transversal rods 32 and the plural vertical rods 2 are assembled to sinter as the one-piece multi-layer sintering carrier 1, the present invention is actually provided with an effect of good ventilation. Besides, the structures of the present invention are simple and the one-piece multi-layer sintering carrier 1 can be customized as various number of layers, height or size, according to customers' demands. In addition, as the one-piece multi-layer sintering carrier 1 itself is a solid body which is formed integrally, it will not tilt or fail during transportation or movement in sintering.

Accordingly, technical keys of the one-piece multi-layer sintering carrier 1 of the present invention, to improve the prior art are that the one-piece multi-layer sintering carrier 1 includes vertical rods 2, the walls of which are provided with the X-directed holes 21 and Y-directed holes 22; the plural X-directed transversal rods 31 and Y-directed transversal rods 32 which are fixed at the X-directed holes 21 and Y-directed holes 22; and the holding plates 4 which are put on the planes formed by the plural X-directed transversal rods 31. By this kind of structures, as there are gaps between the layers at front, rear, left and right of the one-piece multi-layer sintering carrier 1, the good ventilation effect is provided when sintering. In addition, as the one-piece multi-layer sintering carrier 1 is the solid body which is formed integrally, the structures are safe and stable and the carrier 1 will not tilt or fail during transportation or movement in sintering. Furthermore, the type or number of layers of the carrier 1 can be changed according to a dimension of customer's heat treatment equipment or a requirement of ventilation, such that a temperature distribution on a cross section inside the furnace can be more uniform and homogeneity of a product quality can be better.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A one-piece multi-layer sintering carrier comprising:
plural vertical rods, with that X-directed holes and Y-directed holes, which are mutually perpendicular, are provided in spacing on outer walls of the vertical rods, respectively;
plural X-directed transversal rods and plural Y-directed transversal rods which are fixed at the X-directed holes and Y-directed holes, respectively; and
at least two holding plates which are accommodated between the vertical rods, on multi-layer horizontal planes constituted by the plural X-directed transversal rods.

2. The one-piece multi-layer sintering carrier according to claim 1, wherein four vertical rods are provided.

3. The one-piece multi-layer sintering carrier according to claim 1, wherein six vertical rods are provided.

4. The one-piece multi-layer sintering carrier according to claim 1, wherein nine vertical rods are provided.

5. The one-piece multi-layer sintering carrier according to claim 1, wherein the holding plates are penetrated with plural holes.
